(19) United States
(12) Patent Application Publication
(10) Pub. No.: US 2009/0303142 A1
(43) Pub. Date: Dec. 10, 2009

(54) Mounting System and Mounting Procedure for a Vehicle Antenna

(76) Inventors: Henry Lerchner, Hannover (DE); Bernd Flick, Diekholzen (DE)

Correspondence Address: KENYON & KENYON LLP, ONE BROADWAY, NEW YORK, NY, 10004, US

(21) Appl. No.: 12/226,927

(22) PCT Filed: Mar. 26, 2007
(86) PCT No.: PCT/EP2007/052864

§ 371 Date: Jul. 16, 2009

(30) Foreign Application Priority Data
Mar. 12, 2006 (DE) 10 2006 022 392.6

(51) Int. Cl. H01Q 1/32; H01Q 1/50

(52) U.S. Cl. 343/713; 343/906

(57) ABSTRACT

An attachment assemblage for a vehicle antenna has a first antenna-side mechanical attachment component that is connectable to a second mechanical attachment component, and at least one first antenna-side electrical plug component that is connectable to at least one corresponding second electrical plug component. By way of a combined insertion procedure, the first mechanical attachment component is connectable to the second mechanical attachment component, and the at least one first electrical plug component is connectable to the corresponding at least one second electrical plug component, the vehicle antenna being attached to the vehicle body as a result of the connection of the two mechanical attachment components.

### BACKGROUND OF THE INVENTION

1. Field of the Invention

The present invention relates to an attachment assemblage for a vehicle antenna.

2. Description of Related Art

A known attachment assemblage for a vehicle antenna encompasses a first antenna-side mechanical attachment component that encompasses a baseplate having a bolt onto which a nut, embodied as a second mechanical attachment component, is threaded manually in order to install the vehicle antenna on the vehicle body. The nut is threaded onto the bolt on the baseplate of the vehicle antenna in such a way that the vehicle body is clamped between the nut and baseplate. For electrical contacting of the vehicle antenna with a vehicle electrical system, at least one cable that transfers an antenna signal is guided into the interior of the vehicle and connected there, via an electrical plug connection that encompasses a cable-side electrical plug component and a corresponding electrical system-side second electrical plug component, to the vehicle electrical system or to a tuner.

### BRIEF SUMMARY OF THE INVENTION

The attachment assemblage according to the present invention for a vehicle antenna has the advantage that by way of a combined insertion procedure, a first mechanical attachment component is connected to a second mechanical attachment component, and at least one first electrical plug component is connected to a corresponding at least one second electrical plug component. The vehicle antenna is attached to a vehicle body as a result of the connection of the two mechanical attachment components, and electrical contacting between the vehicle antenna and a vehicle electrical system is produced by the electrical plug connection. By way of the attachment assemblage according to the present invention, attachment of the antenna to the vehicle body, and the electrical contacting procedure, can advantageously be performed in one working step. Electrical contacting can advantageously be ensured by the mechanical attachment.

The attachment method according to the present invention for a vehicle antenna advantageously makes it possible, after introduction of a guide stud of a baseplate having at least one first electrical plug element into a corresponding opening in the vehicle body, to latch first springs, disposed on the guide stud, under the vehicle body for pre-fastening. Placement of a receiving part, having a depression that corresponds in shape and dimensions to the guide stud and having at least one second electrical plug element that corresponds to the at least one first electrical plug element, onto the pre-fastened guide stud advantageously results simultaneously in a mechanical attachment of the guide stud to the placed-on part and in electrical contacting between the first and the second electrical plug element. Second springs disposed on the guide stud latch with the receiving part for pre-fastening. Threading a screw, connected in lossproof fashion to the receiving apparatus and/or to an attachment bracket, into a corresponding threaded orifice in the baseplate and/or in the guide stud causes the at least one first electrical plug element and the at least one second electrical plug element to be pushed into their final contacting position, and causes the body panel to be clamped between the attachment bracket and the baseplate.

It is particularly advantageous that the first mechanical attachment component encompasses a baseplate having a guide stud. The guide stud is, for example, disposed on the underside of the baseplate and has, for example, a substantially square cross section. Introduced into this guide stud are recesses and/or apertures that receive the at least one first electrical plug component.

In an example embodiment of the attachment assemblage according to the present invention, the second mechanical attachment component encompasses a receiving part having a depression whose internal shape and dimensions correspond to the external shape and dimensions of the guide stud of the baseplate, in order to receive the guide stud in a form-locking manner during the insertion procedure. The receiving part encompasses, for example, recesses and/or apertures that receive the at least one second electrical plug component, which latter is respectively connected to a corresponding cable of the vehicle electrical system.

In a further example embodiment of the attachment assemblage according to the present invention, a first spring is positioned laterally on the guide stud in a recess, and projects beyond the cross section of the guide stud in order to enable pre-fastening of the baseplate onto the vehicle body. The receiving part can be pre-fastened onto the guide stud by way of a second spring that is positioned laterally on the guide stud in a recess inside the cross section of the guide stud. The first and second springs are, for example, respectively embodied as spring pairs and coupled to one another.

In a further example embodiment of the attachment assemblage according to the present invention, an attachment bracket is placed onto the receiving part and a screw connects the receiving part and the baseplate, the screw being attached in lossproof fashion to the attachment bracket and/or to the receiving part and being threadable, after the insertion procedure, into a corresponding threaded orifice in the baseplate and/or in the guide stud.

### BRIEF DESCRIPTION OF THE SEVERAL VIEWS OF THE DRAWING

FIG. 1 shows a perspective depiction of a first mechanical attachment component of an attachment assemblage according to the present invention for a vehicle antenna.

FIGS. 2 through 4 show perspective depictions of individual components of the first mechanical attachment component according to FIG. 1.

FIG. 5 shows a perspective depiction of a second mechanical attachment component of the attachment assemblage according to the present invention for a vehicle antenna.

FIGS. 6 through 10 show perspective depictions of individual components of the second mechanical attachment component according to FIG. 5.

FIG. 11 shows a perspective depiction of the first mechanical attachment component according to FIG. 1, introduced into an opening in a vehicle body.

FIG. 12 shows a perspective depiction of the installed attachment assemblage according to the present invention for a vehicle antenna.

FIG. 13 shows a sectioned depiction, along the offset section line A-A in FIG. 12, of the attachment assemblage according to the present invention for a vehicle antenna.

### DETAILED DESCRIPTION OF THE INVENTION

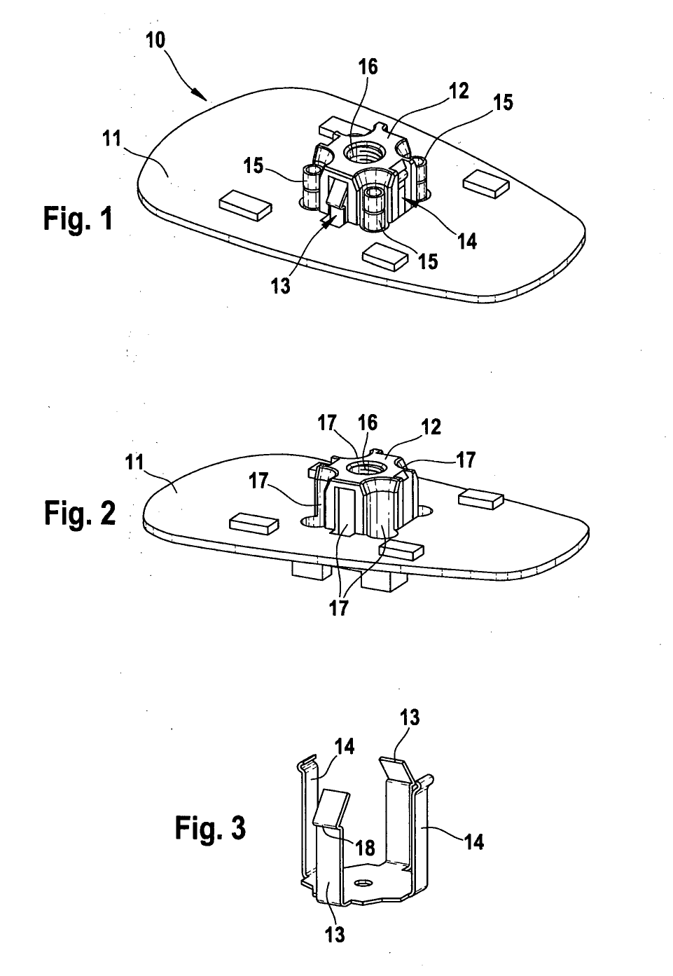

FIGS. 1 through 4 show components of a first mechanical attachment component 10 of an attachment assemblage 1 according to the present invention for a vehicle antenna; FIG. 1 shows the assembled first mechanical attachment component 10, and FIGS. 2 through 4 show individual constituents of the first mechanical attachment component. As is evident from FIGS. 1 through 4, the first antenna-side mechanical attachment component 10 encompasses a baseplate 11 having a guide stud 12. Guide stud 12 is disposed on an underside of baseplate 11 and has a substantially square cross section. Introduced into guide stud 12 are a threaded orifice 16 and recesses and/or apertures that, in the exemplifying embodiment depicted, receive four first electrical plug components 15 embodied as male HF plug connectors, and a first spring pair 13 and a second spring 14. The four first electrical components 15 are pressed in the corners into recesses 17 of the square guide stud 12 of baseplate 11 of the vehicle antenna. First and second spring pair 13, 14, which are connected to one another, are installed on baseplate 11 for pre-fastening. The two spring pairs 13, 14 are positioned on the sides of the square cross section of guide stud 12, first spring pair 13 protruding laterally beyond the square cross section of guide stud 12 in order to hold the vehicle antenna on the vehicle body during the installation procedure. Second spring pair 14 is disposed inside the cross section of guide stud 12, and fastens a second mechanical attachment component 20 of the attachment assemblage according to the present invention during the installation procedure.

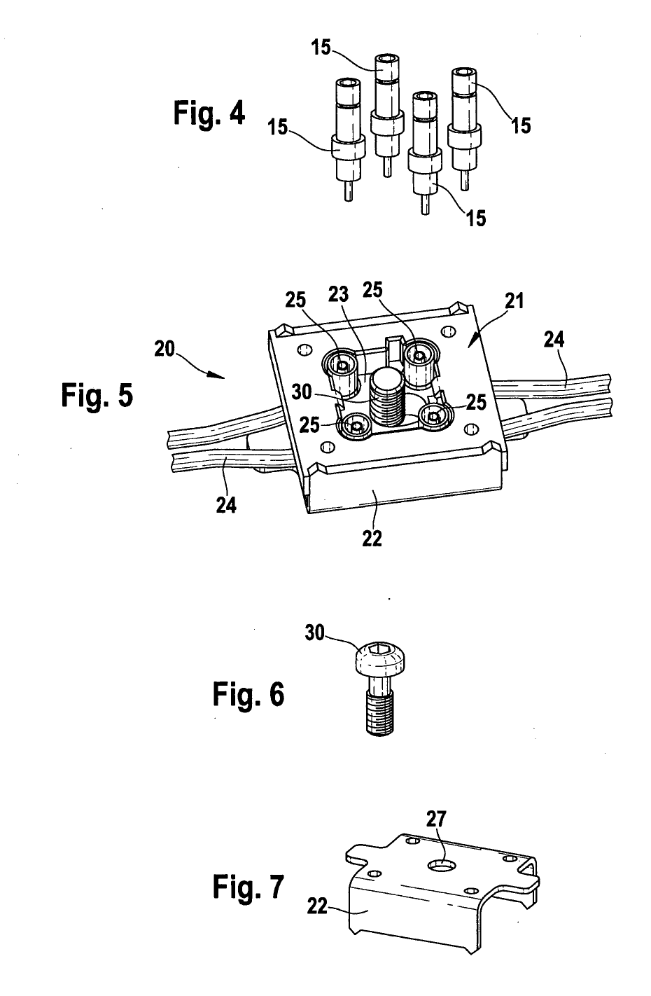

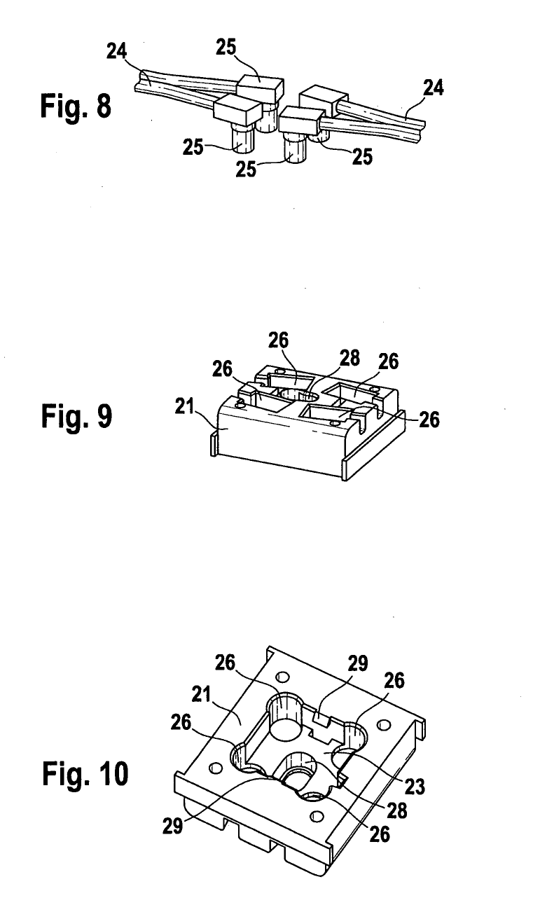

FIGS. 5 through 10 show components of a second mechanical attachment component 20 of attachment assemblage 1 according to the present invention for a vehicle antenna; FIG. 5 shows the assembled second mechanical attachment component 20, and FIGS. 6 through 10 show individual constituents of the first mechanical attachment component. As is evident from FIGS. 5 through 10, second mechanical attachment component 20 encompasses a receiving part 21 having a depression 23 whose internal shape and dimensions correspond to the external shape and dimensions of guide stud 12 of baseplate 11 in order to receive guide stud 12 in a form-locking manner during an insertion procedure. In the exemplifying embodiment depicted, depression 23 of receiving 21 has a substantially square cross section, corresponding to guide stud 12. Receiving part 21 has recesses 26 and/or apertures that, in the exemplifying embodiment depicted, receive four second electrical plug components 25 embodied as female HF plug connectors. The four second electrical plug components 25 are each connected, for example by way of a crimped connection, to a corresponding cable 24 of the vehicle electrical system or of a tuner. As is further evident from FIGS. 5 through 10, an attachment bracket 22 is placed onto receiving part 21, and a screw 30 is attached in lossproof fashion to attachment bracket 22 and/or to receiving part 21 for fixed connection of first mechanical attachment component 10 to second mechanical attachment component 20. After the insertion procedure, screw 30 is threadable into threaded orifice 16 in guide stud 12 of baseplate 11.

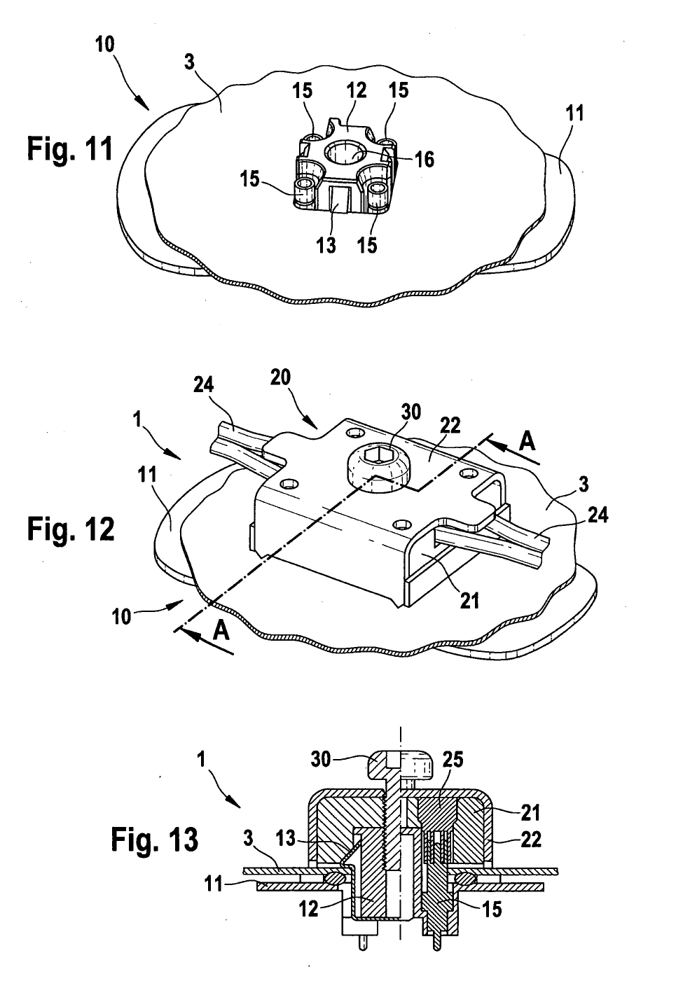

FIG. 11 is a perspective depiction of first mechanical attachment component 10 introduced into the opening in vehicle body 3. As is evident from FIG. 11, guide stud 12 of baseplate 11 having the complete vehicle antenna is inserted through a corresponding opening in vehicle body 3 for installation on vehicle body 3, for example on a vehicle roof, rear deck, fender, etc. In this context, latching lugs 18 of first spring pair 13 latch under vehicle body 3 for pre-fastening.

FIG. 12 is a perspective depiction of the completely installed attachment assemblage 1 according to the present invention for a vehicle antenna, and FIG. 13 is a sectioned depiction along offset section line A-A in FIG. 12. As is evident from FIGS. 12 and 13, second mechanical attachment component 20 is placed onto guide stud 12 of baseplate 11 after the pre-fastening of first mechanical attachment component 10 onto vehicle body 3, the positioning of second mechanical attachment component 20 being accomplished by the square fit between depression 23 in receiving part 21 and guide stud 12. Simultaneously with the placement of second mechanical attachment component 20 onto first mechanical attachment component 10, first electrical plug components 15 and second electrical plug components 25 are also plugged together. Receiving part 21 latches, via second spring pair 14, with guide stud 12 on baseplate 11. This is implemented by way of two latching hooks 29 that latch behind second spring pair 14 for pre-fastening.

After second mechanical attachment component 20 has been placed onto first mechanical attachment component 10, screw 30 is threaded into the corresponding threaded orifice 16 in baseplate 11. First and second electrical plug components 15, 25 are thereby pushed into their final positions, and vehicle body 3 is clamped between attachment bracket 22 and baseplate 11. Attachment bracket 22 and receiving part 21 have corresponding apertures 27, 28 in order to guide screw 30.

The attachment assemblage according to the present invention advantageously makes it possible to connect first mechanical attachment component 10 to second mechanical attachment component 20, and the at least one first electrical plug component 15 to the corresponding at least one second electrical plug component 25, by way of a combined insertion procedure, the vehicle antenna being attached to vehicle body 3 as a result of the connection of the two mechanical attachment components 10, 20, and electrical contacting between the vehicle antenna and a vehicle electrical system being produced by the electrical plug connection.

1-10. (canceled)

11. An attachment assemblage for coupling a vehicle antenna to a vehicle body, comprising:
a first antenna-side mechanical attachment component;
a second mechanical attachment component, wherein the first and second mechanical attachment components are configured to be connected to one another;
at least one first antenna-side electrical plug component; at least one second electrical plug component, wherein the first and second electrical plug components are configured to be connected to one another in order to produce electrical contacting;
wherein the vehicle antenna is configured to be attached to the vehicle body as a result of a connection of the first and second mechanical attachment components, and wherein electrical contacting between the vehicle antenna and a vehicle electrical system is produced as a result of a connection of the first and second electrical plug components, and wherein the connection of the first and second mechanical attachment components and the connection of the first and second electrical plug components are achieved by a substantially simultaneous coupling.

12. The attachment assemblage as recited in claim 11, wherein the first mechanical attachment component includes a baseplate having a guide stud.

13. The attachment assemblage as recited in claim 12, wherein the guide stud has at least one of a recess and an aperture configured to receive the first electrical plug component.

14. The attachment assemblage as recited in claim 13, wherein the second mechanical attachment component includes a receiving part having a depression, and wherein internal shape and dimensions of the depression correspond to external shape and dimensions of the guide stud of the baseplate in order to receive the guide stud in a form-locking manner during the coupling.

15. The attachment assemblage as recited in claim 14, wherein the receiving part has at least one of a recess and an aperture configured to receive the second electrical plug component, and wherein the second electrical plug component is connected to a corresponding cable of the vehicle electrical system.

16. The attachment assemblage as recited in claim 14, further comprising:
a first spring configured for pre-fastening the baseplate onto the vehicle body, wherein the first spring is positioned laterally on the guide stud in the recess of the guide stud and projects beyond the cross section of the guide stud.

17. The attachment assemblage as recited in claim 16, further comprising:
a second spring configured for pre-fastening the receiving part, wherein the second spring is positioned laterally on the guide stud in the recess of the guide stud.

18. The attachment assemblage as recited in claim 17, wherein the first and second springs are connected to one another.

19. The attachment assemblage as recited in claim 14, further comprising:
an attachment bracket positioned on the receiving part; and
a screw configured for fixedly connecting the receiving part and the baseplate, wherein the screw is configured to be attached to at least one of the attachment bracket and the receiving part, and wherein the screw is configured to be threaded, after the coupling, into a corresponding threaded orifice in at least one of the baseplate and the guide stud.

20. A method for attachment of a vehicle antenna to a vehicle body panel, comprising:
introducing a guide stud of a baseplate having at least one first electrical plug element into a corresponding opening in the vehicle body panel, whereby at least one first spring disposed on the guide stud latches under the vehicle body panel for pre-fastening;
plugging on a receiving part at least one second spring disposed on the guide stud, wherein the receiving part has a depression that corresponds in shape and dimensions to the guide stud, and wherein the receiving part has at least one second electrical plug element that corresponds to the at least one first electrical plug element, whereby the at least one second spring latches with the receiving part for pre-fastening the receiving part; and
threading a screw into a corresponding threaded orifice in at least one of the baseplate and the guide stud, wherein the screw is connected to at least one of the receiving part and an attachment bracket, and wherein the threading of the screw results in: a) the at least one first electrical plug element and the at least one second electrical plug element being pushed into a contacting position; and b) the vehicle body panel being clamped between the attachment bracket and the baseplate.
